(19) United States
(12) Patent Application Publication
(10) Pub. No.: US 2007/0237909 A1
(43) Pub. Date: Oct. 11, 2007

(54) Glossy media sheet

(76) Inventor: Richard J. McManus, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/398,786

(22) Filed: Apr. 6, 2006

(51) Int. Cl. B41M 5/50

(52) U.S. Cl. 428/32.34

(57) ABSTRACT

A media sheet has an image-receiving layer that includes about 30 to about 70 percent calcined clay.

### BACKGROUND

With the demand for customized print matter, such as mailings, catalogs, brochures, and flyers increasing and the desire to optimize printer efficiency in regard to job set up times, particularly on smaller run sizes, digital copiers and presses have become more ubiquitous in the printing industry. Digital printers encompass a range of technologies including electrophotographic and inkjet technologies. To take full advantage of these systems, the media that are printed often need to be optimized for that particular technology. Media for some inkjet technologies should to be highly absorptive. Typical glossy media for the above mentioned applications are not designed for inkjet technology. Instead, they have been designed for offset or gravure type printing presses, whose demand for absorptivity is very low when compared with an inkjet system. Media with low absorptivity will result in inefficient drying of the printed image that can lead to printer contamination, image smearing, and reduced performance.

### DESCRIPTION OF THE DRAWINGS

FIG. 1 is a cross-sectional view of a media sheet, according to an embodiment of the invention.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

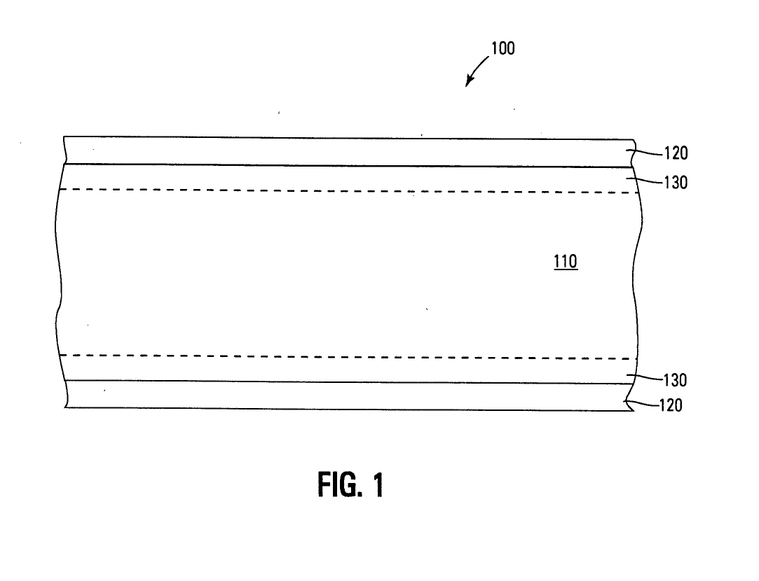

FIG. 1 is a cross-sectional view of a media sheet 100, such as a coated-grade media sheet, e.g., suitable for use in an imaging device, such as a color ink-jet printer, according to an embodiment. Media sheet 100 includes a substrate 110, such as of paper, e.g., fabric paper stock, or the like. An image-receiving layer (or coating) 120 is formed on substrate 110. For one embodiment, image-receiving layer 120 is formed either on opposing (upper and lower) surfaces of substrate 110, as shown, or on one of the surfaces of substrate 110.

For one embodiment, image-receiving layer 120 has a gloss level above about 50 as measured at a 75-degree view angle. For a preferred embodiment, the image-receiving layer 120 has a gloss level of about 65 to about 75 as measured at a 75-degree view angle using a Micro-gloss 75 75-degree gloss meter manufactured by BYK-Gardner GmbH (Geretsried, DE). The gloss of the image-receiving layer can be achieved through, but is not limited to, such processes as calendering, super-calendering, and casting of the imaging layer. For another embodiment, image-receiving layer 120 has a thickness greater than about 1 micron. For example, in one embodiment, image-receiving layer 120 has a thickness of about 2 microns to about 50 microns. Note that image-receiving layer 120 is the outermost layer of media sheet 100. For one embodiment, image-receiving layer 120 receives marking fluid, e.g., liquid ink droplets, ejected from an imaging device during a printing process.

For various embodiments, image-receiving layer 120 includes first and second pigments as described below. An optional third pigment is also described below. For another embodiment, image-receiving layer 120 may also include one or more binders that may include, but are not limited, to polyvinylalcohol, polyvinylacetates, polyacrylates, polymethacrylates, polystyrene-butadiene, polyethylene-polyvinyacetate copolymers, starch, casein, gelatin and mixtures and copolymers thereof. Other additives, such as colorants, optical brighteners, defoamers, wetting agents, rheology modifiers and other additives known in the art may be added for some embodiments.

For one embodiment, image-receiving layer 120 includes at least first and second pigments. For another embodiment, the first pigment acts to provide an absorption characteristic of image-receiving layer 120 so that marking fluid ejected onto image-receiving layer 120 is sufficiently dry after an imaging device has finished disposing images on image-receiving layer 120. For one embodiment, the first pigment is calcined clay, such as ANSILEX 93, manufactured by Englehard Corporation (Iselin, N.J., U.S.A.), or NEOGEN 2000, manufactured by Imerys Pigments, Inc. (Roswell, Ga., U.S.A.). For one embodiment, image-receiving layer 120 is about 25 to about 70 percent, by dry weight, calcined clay. For a preferred embodiment, image-receiving layer 120 is about 35 to about 60 percent, by dry weight, calcined clay. Calcined clay amounts above about 70 percent may result in poor gloss and image mottling, while calcined clay amounts below about 25 percent may result in poor absorption. For another embodiment, the calcined clay has a median esd (equivalent spherical diameter) of less than about 1.6 microns as determined by a Microtrac-UPA150 laser light scattering device. For some embodiments, the calcined clay has an oil absorption of greater than about 100 grams of oil per 100 grams of calcined clay as determined according to American Society of Testing and Materials (ASTM) standard ASTM D 281-95.

The second pigment acts to provide a gloss characteristic of image-receiving layer 120 and to improve the uniformity of the ink absorption thus leading to a reduction in mottle of the printed image that is apparent when using a calcined clay pigment as the sole inorganic pigment in the image layer 120. For one embodiment, the second pigment is an inorganic pigment, such as an ultrafine kaolin clay, such as MIRAGLOS 91, manufactured by Englehard Corporation (Iselin, N.J., U.S.A.), or POLYGLOSS 90, manufactured by J.M. Huber Corporation (Edison, N.J., U.S.A.). Another suitable inorganic pigment may be precipitated calcium carbonate, preferably of aragonitic crystalline structure, such as Opacarb A40, manufactured by Specialty Minerals, Inc. (Bethlehem, Pa., U.S.A.). For some embodiments, the kaolin clay and the calcium carbonate have a median esd of less than about 650 nanometers as determined by a Microtrac-UPA150 laser light scattering device. For example, in one embodiment image-receiving layer 120 is comprised of calcined clay between about 25 and about 70 percent and of a second pigment from about 30 to 60 percent by dry weight of the image-receiving layer 120.

For another embodiment, image-receiving layer 120 may include, first, second, and third pigments. The third pigment may be a plastic pigment made of polystyrene, polymethacrylates, or polyacrylates or copolymers thereof for one embodiment. The plastic pigments may be of the solid or hollow. However, the preferred form is the solid type with a median esd of less than about 500 nanometers. Examples of such particles are 788A, 756A and 722HS from Dow Chemical (Midland, Mich., U.S.A.) For example, in one embodiment, image-receiving layer 120 may include calcined clay, kaolin clay, and a plastic pigment. For another embodiment, image-receiving layer 120 includes about 25 to 70 percent calcined clay for absorption, about 30 to 60 percent ultrafine kaolin clay for gloss and improved imaging, and about 1 to 4 percent plastic pigment for added gloss by dry weight. For another embodiment, image-receiving layer 120 includes about 25 to 70 percent calcined clay for absorption, about 30 to 60 percent precipitated calcium carbonate for gloss and improved imaging, and about 1 to 4 percent plastic pigment for added gloss by dry weight.

For one embodiment, applying an aqueous coating to the upper or upper and lower surfaces of substrate 110 forms image-receiving layer 120. For one embodiment, the aqueous coating is in the form of an aqueous suspension, e.g., that includes about 35 to about 65 percent solids, with the solids including the first and second pigments or the first, second, and third pigments, described above. For other embodiments, an optional pre-coat (or intermediate layer) 130, e.g., comprised of silica, alumina, calcined clay, calcium carbonate, kaolin clay etc., may be formed on the upper or upper and lower surfaces of substrate 110 before forming image-receiving layer 120, with image-receiving layer 120 being formed on intermediate layer 130. For one embodiment, coating the upper or upper and lower surfaces of substrate 110 with an aqueous suspension containing the components of intermediate layer 130 forms intermediate layer 130.

### CONCLUSION

Although specific embodiments have been illustrated and described herein it is manifestly intended that the scope of the claimed subject matter be limited only by the following claims and equivalents thereof.

What is claimed is:

1. A media sheet comprising:
a substrate; and
an image-receiving layer formed on the substrate;
wherein the image-receiving layer comprises about 25 to about 70 percent calcined clay by dry weight.

2. The media sheet of claim 1, wherein the image-receiving layer further comprises at least one of kaolin clay, precipitated calcium carbonate, and a plastic pigment.

3. The media sheet of claim 1, wherein the image-receiving layer further comprises about 30 to about 60 percent kaolin clay or about 30 to about 60 percent precipitated calcium carbonate, and about 0 to about 5 percent plastic pigment by dry weight.

4. The media sheet of claim 1, wherein the calcined clay has a median particle size of less than about 1.6 microns.

5. The media sheet of claim 1, wherein the calcined clay has an oil absorption of greater than about 100 grams of oil per 100 grams of calcined clay.

6. The media sheet of claim 1 further comprises an intermediate layer interposed between the substrate and the image-receiving layer.

7. The media sheet of claim 6, wherein the intermediate layer is selected from the group consisting of silica, alumina, and calcined clay, kaolin clay, calcium carbonate, sodium and potassium aluminates, sodium and potassium silicates, aluminum trihydrate, titanium dioxide and hydrated alumina.

8. A media sheet comprising:
a paper substrate; and
an image-receiving layer formed on the paper substrate;
wherein the image-receiving layer comprises at least first and second pigments;
wherein the first pigment is calcined clay that makes up about 25 to about 70 percent of the image-receiving layer by dry weight and has an oil absorption of greater than about 100 grams of oil per 100 grams of calcined clay; and
wherein the second pigment is an inorganic pigment.

9. The media sheet of claim 8, wherein the calcined clay has a median particle size of less than about 1.6 microns.

10. The media sheet of claim 8, wherein the second pigment has a median particle size of less than about 650 nanometers.

11. The media sheet of claim 8 further comprises an intermediate layer interposed between the substrate and the image-receiving layer.

12. The media sheet of claim 8, wherein the gloss of the image-receiving layer is greater than about 50 when measured at a 75 degree viewing angle.

13. A method of forming a media sheet, comprising:
forming an image-receiving layer overlying a substrate, the image-receiving layer comprising about 25 to about 70 percent calcined clay by dry weight.

14. The method of claim 13, wherein forming an image-receiving layer overlying a substrate comprises coating the substrate with an aqueous coating.

15. The method of claim 14, wherein the aqueous coating comprises the calcined clay and at least kaolin clay, precipitated calcium carbonate, or both the kaolin clay and the precipitated calcium carbonate.

16. The method of claim 13, wherein the image-receiving layer further comprises at least kaolin clay, precipitated calcium carbonate, or both.

17. The method of claim 13 further comprises pre-coating the substrate before forming the image-receiving layer.

18. A method of printing, comprising:
disposing a marking material on an image-receiving layer of a media sheet;
wherein the image-receiving layer comprises about 25 to about 70 percent calcined clay by dry weight.

19. The method of claim 18, wherein disposing a marking material on an image-receiving layer of a media sheet comprises ejecting liquid droplets of the marking material onto the image-receiving layer.

20. The method of claim 18, wherein the image-receiving layer further comprises at least kaolin clay, precipitated calcium carbonate, or both.
